(19) United States
(12) Patent Application Publication
(10) Pub. No.: US 2001/0032165 A1
(43) Pub. Date: Oct. 18, 2001

(54) Method and apparatus for internet connectivity for agriculture buyers,sellers and transporters

(76) Inventors: Ralph K. Friend, Tipton, CA (US); Diane B. Friend, Tipton, CA (US); John M. Greenelsh, Grover Beach, CA (US); David J. Isham, Santa Maria, CA (US); Jeffrey L. Allen, San Luis Obispo, CA (US)

Correspondence Address: STRADLING YOCCA CARLSON & RAUTH, IP Department, P. O. Box 7680, 660 Newport Center Drive, Suite 1600, Newport Beach, CA, 92660-6441, US

(21) Appl. No.: 09/747,329

(22) Filed: Dec. 21, 2000

Related U.S. Application Data
(60) Provisional application No. 60/171,684, filed on Dec. 21, 1999.

(51) Int. Cl. G06F 17/60

(52) U.S. Cl. 705/37; 705/26

(57) ABSTRACT

A first participating entities prepares a transaction offer notice on a data processing system. The transaction offer notice is stored in a database of such notices on a server system which is available to entities participating in the system. Transaction notices contained within the server system's database are available to a user community over the Internet and form the basis of a trading platform. Users are able to search the database for transaction offer notices that satisfy a set for search criteria, and are able to electronically negotiate with the offeror with respect to transaction parameters and other terms and conditions until the transaction is acceptable to both parties. The original transaction offer notice is retained in the database and is further available to the user community while negotiations are proceeding. Transaction offer notices are able to be posted by any participating entity, and once a transaction is consummate, transactions details are forwarded to a third-party financial institution for fund transfer.

### CROSS-REFERENCE TO RELATED APPLICATIONS

This application claims priority from provisional Application No. 60/171,684 filed on Dec. 21, 1999, entitled METHOD AND APPARATUS FOR INTERNET CONNECTIVITY FOR AGRICULTURE BUYERS, SELLERS AND TRANSPORTERS

### FIELD OF THE INVENTION

The present invention relates generally to systems and methods for electronic commodity trading and, more particularly to improve data processing based systems for implementing commodity transactions within a network environment.

### BACKGROUND OF THE INVENTION

Agricultural commodities, products and services represent some of the goods and services that must be traded between growers, vendors and shippers in order to be efficiently distributed to the ultimate consumer. Over the years, many institutions have been established which allow these types of items to be purchased, sold and eventually distributed, such that our society might feed itself and eventually thrive. Within these institutions, producers, vendors, distributors and shippers have typically built their business on handshakes and alliances, currently relying almost exclusively on the telephone and facsimile machine in order to transfer information relating to item availability, quality, price, and the like. The typical sales process might begin with a hard-copy distribution being sent out to key customers, listing particular crops or products that will be harvested or produced, and including proposed prices for various lot sizes of these items. As the process unfolds, an army of sales representatives contact as many buyers or sellers as possible, with the sales force representing crop or product characteristics, haggling over quality, and perhaps swapping this favor for that concession, and the like. This particular “system” has resulted in a highly fragmented and inefficient marketplace, in which agricultural producers have witnessed substantial aggregate price decreases during a period of substantial aggregate cost escalation, resulting in a consequent reduction in total compensation, during the decade of the 1990s. It is apparent that the institutions established for agricultural commodity, product and service trading in the preceding years have been highly deficient, at least from the perspective of the average agricultural producer.

Concurrent with the observed decrease in average agricultural commodity prices, trading participants are being confronted with a multiplicity of new electronic transaction promotion schemes, such as Bto-B exchanges, which introduce auction and broker business models to the agricultural commodity and product acquisition marketplace. Each of these electronic brokering schemes has some small degree of efficiency to recommend it, but all are generally configured to add more value to the buyer's side of the equation than to the seller's side. Increased competition in both the national and global marketplace, as well as rapid advances in technology, are tending to push more and more of these electronic commodity brokerages into the forefront of the agricultural trading marketplace. Marketplace participants are not surprisingly wary of this trend.

Auctions themselves are relatively anti-competitive, with no participant knowing how any other participant is pricing their product, or what the actual scope and result of the bidding process is. Once receiving a specific bid for a crop or product, a producer/vendor has no way of knowing whether another participant might have made a higher bid, but instead chose not to engage with that particular seller because of other considerations. Auctions are therefore an inefficient way to value commodities or products; so inefficient that other marketplaces, such as the security exchange marketplace, abandoned them over a century ago. Further, local time differences and physical distance, combined with short settlement periods and the natural volatility of the agricultural marketplace, increases the risks for all of the trading participants. While the current suite of electronic trading products have reduced the risk somewhat for the buyer and/or the executing broker by automating the confirmation process, none of these electronic trading products has provided an efficient method for promoting engagement directly between buyers and sellers in such a way that each is able to determine the full scope and content of the entire marketplace.

What is required is a system and method whereby individuals or institutions can buy and sell agricultural commodities, products and services, directly between one another with only a minimal time differential and with minimal risk. In such a system, and in accordance with such a method, individual buyers and sellers would be in substantially similar positions with respect to one another, i.e., they would have access to all of the other offers made by all other individual buyers or sellers wishing to purchase or sell agricultural commodities, products and/or services. In such a system, an individual buyer or seller would be able to select among many competing offers to buy and sell and thus would be able to obtain a significantly better transaction than would be the case under present circumstances. Additionally, in such a system, an individual buyer or seller would be able to negotiate individual transaction parameters, such as price, quantity, quality, or specific delivery terms and conditions, with the other party, while at the same time having recourse to all other similar offers to buy or sell within a reasonable trading or transaction radius.

Concern with transaction payment would be minimized in such a system by coupling the system to third-party financial institutions, such that transaction data, including a history of the individual transaction, can be electronically transferred to the third-party financial institution in order to provide a security or record basis for the transfer of funds. Buyers would be able to transfer funds into an escrow service, with the transaction details generated by the system defining the escrow conditions. As the escrow conditions are met, the escrow service transfers funds to the seller and the transaction is completed.

With such a system and method, smaller growers or vendors would be able to gain access to “best practice” systems and current trading data, allowing them to command higher prices for their output. In this particular regard, the competitive bidding aspects of an efficient market mechanism should tend to increase prices for agricultural commodities in a manner quite similar to how the efficient market mechanism increases prices for valuable securities and equities.

Developing such a system would allow buyers and sellers to lessen, or even eliminate, their reliance upon middlemen such as brokers, while further enabling sellers to reach a vastly larger market. Sellers would no longer be limited to selling their output to only as many entities as their sales staff are able to directly contact. Additionally, such a system would allow buyers to satisfy their chief concern, i.e., being able to source product better, by giving a buyer the ability to view all of the available sellers, and the current market prices, of the universe of agricultural commodities, products and services. Having such a wealth of data at their fingertips will result in enormous time-savings, thereby allowing a single buyer to perform activities and accomplish results currently requiring a substantial organization.

In summary, such a system and method will provide a unique value proposition that appeals to both parties in the agricultural commodity, product and service marketplace. When implemented in accordance with the embodiments described herein, such systems and methods will determine how such items are best able to come to market in the emerging new economy.

### SUMMARY OF THE INVENTION

A method for affecting efficient electronic transactions in an agricultural market place compromises of establishing an agricultural trading platform which includes a communication network linking a community of buyers and sellers of agricultural items. A database is established and structured in accordance with a categorical hierarchical structure, the top-level categories of the database, corresponding to top-levels market subdivisions compromising the agriculture related market place. Transaction notices are received from participating entities over the communication network, each transaction notice including item transaction parameter data, organized in accordance with the top-level market categories. The database can be search for transaction notices in accordance with a selection criteria which corresponds to the database's higher categorical hierarchical structure. Transaction notices that satisfy the selective search category are displayed to a user and the user is allowed to access selected ones of the display transaction notices so as to display a detail of the corresponding item transaction parameter data. If the user is interested in completing a transaction, they may respond to an access transaction notice so as to complete the transaction.

In one aspect of the invention, a user may respond to an access transaction notice by negotiating with the originating party. The user electronically modifies at least one items transaction index and submits the modified transaction notice to the participating entity that originated the transaction notice. The modification and submission steps are repeated, in alternating fashion, between the originator and the negotiator, until the item transaction parameters of the transaction notice are acceptable to both parties. A historical record of each modification of by either party is maintained in the database and an electronic transaction consummation record, containing the final item transaction parameters agreed upon by both parties, is generated by the system.

In an additional aspect of the invention, the transaction consummation record is forward to a third-party financial institution, where the agreed item transaction parameters define the transaction conditions, the satisfaction of which triggers a transfer of funds. In particular, such a third-party financial institution might include an escrow service, with the agreed item transaction parameters defining the escrow conditions.

In a particular aspect of the invention, the top-level market subdivision are identified as commodities, products, services and transportation, and are further subdivided into item categories corresponding to rational groupings of items within each top-level subdivision. Participating entities are associated with one of a number of entity types, where each entity type is associated with a corresponding top-level market subdivision. As a participating entity which is to generate a transaction notice, blank transaction notices, in the form data records, are presented to each participating entity in accordance with their identified entity type. In this manner, entities which deal in agricultural commodities will be able to transact in accordance with a data record which has appropriate commodity parameter fields, while entities associated with products or services, different from commodities, will transact with one another in accordance with data records having different transaction parameters.

Transaction parameters form the basis of searching, with a user able to search for transaction notices either within particular categories, or for transactions occurring within a particular geographical radius, or both. Transaction notices that satisfy a user's search criteria are displayed to a user in a list form so as to enable the user to gain an immediate impression of the scope of the market for that particular commodity.

In an additional aspect, the invention is provided as an application software program residing on a server systems, which users may access through a browser application over the Internet. Transaction notices, as well as other user specific information is maintained in a database, with transaction notices posted by various users of being available to the user community as a whole. Users are able to access individual transaction notices from the universe of such notices and negotiate details of transaction with the offeror while the offerors transaction notice remains available to others in its original form.

### BRIEF DESCRIPTION OF THE DRAWINGS

These and other features, aspects and advantages of the present invention will be best understood with reference to the following detailed description, appended claims and accompanying drawings wherein:

FIG. 1 is a semi-schematic partial block diagram of a network-based data processing system in accordance with the practice and principles of the present invention;

FIG. 2 is a semi-schematic partial block diagram of a user interface portion of the network-based data processing system of FIG. 1;

FIG. 3 illustrates a more detailed block diagram of the component parts of the user interface suitable for use with the network-based data processing system of FIG. 1;

FIG. 4 illustrates a more detailed block diagram of the component parts of a central server system, suitable for use with the network-based data processing system of FIG. 1;

FIG. 5 is a simplified, block level diagram of the structural and functional organization of the activities supported by a trading platform in accordance with the practice and principles of the invention;

FIGS. 6a-6d are exemplary lists of the categorical organization of each of the four top-level markets, into which the database of the trading platform is organized;

FIG. 7a is a simplified, semi-schematic representation of a simple search screen, in accordance with the present invention;

FIG. 7b is a simplified, semi-schematic representation of an advanced search screen, in accordance with the invention;

FIG. 8 is a simplified, semi-schematic representation of a search result screen, illustrating offers to sell and requests for quote;

FIG. 9 is a simplified, semi-schematic representation of an offer to sell data entry record screen, configured for the top-level product market, in accordance with the invention;

FIG. 10 is a simplified, semi-schematic representation of a request for quote data entry record screen, configured for the top-level commodity market, in accordance with the invention;

FIG. 11a is a simplified, semi-schematic representation of a product sales order generated by the system, in accordance with the invention;

FIG. 11a is a simplified, semi-schematic representation of a commodity sales order generated by the system, in accordance with the invention; and

FIG. 12 is a simplified, semi-schematic representation of an account management screen indicating the various activity categories with which a trading platform member entity may interact, in accordance with the invention.

### DETAILED DESCRIPTION OF THE INVENTION

The present invention is directed, generally, to a comprehensive business-to-business application service that empowers various industries, such as agriculture, food, fiber and materials, with a standardized commodity trading platform supporting the global buying and selling of raw commodities, processed commodities, goods, services and transportation. The trading platform, in accordance with the invention, is implemented as a suite of services, that is aggregated into an application service program, hosted on an application server coupled to a wide area network, such as the Internet.

The particular suite of suite of services hosted by the trading platform includes a set of applications directly related to both procurement (purchasing) and marketing (selling) of any number of items that fall within certain categories of goods and services, hosted by the system. In addition to procurement and marketing, the trading platform further supports a distribution mechanism, by which goods and services are moved from a point of origin to a location designated by a procurement agency, for example. Distribution services might include any form of product movement methodology such as cargo transportation by truck, air freight, over-water bulk cargo transportation, rail transportation and the like, and would also be able to accommodate a shippers' dealing with various import/export restrictions and requirements, bulk cargo breakdown, and other logistical elements associated with commodity distribution.

In addition to supporting the procurement, marketing and distribution of goods and services, the trading platform is further configured to facilitate real-time transaction financial services, with regard to any particular transaction or set of transactions, such that buyers and sellers are assured of timely payment upon satisfaction of a particular set of mutually agreed upon criteria. Transactional services, offered by the trading platform in accordance with the invention, are a particularly advantageous feature of the system, when it is considered that arms-length transactions are made even more so, by the amenity inherent in an electronic commerce system.

Given the procurement, marketing, distribution and transaction services available through the suite of services offered in accordance with the present invention, it should be understood that the data inherent in such a set of functionality is able to easily support management and analysis tools which function to process the various transactions which are supported by the system in order to develop real-time supply/demand reports, industry focused content reports, commerce management statistics and systems, and the like. In summary, the trading platform, in accordance with the invention, offers a full suite of services that meets the needs of diversified producers, processors, distributors, transporters and the like.

Since the trading platform is hosted, supported and maintained on a data base server, or distributed server, in a network environment, platform clients are able to participate in a global commodity marketplace at minimal expense and with no requirement for complex implementation or management resources. Even though the platform is implemented over a considerable range of goods and services, the platform is adapted to provide a unified transaction flow across product lines utilizing an intuitive interface that includes a custom negotiation engine.

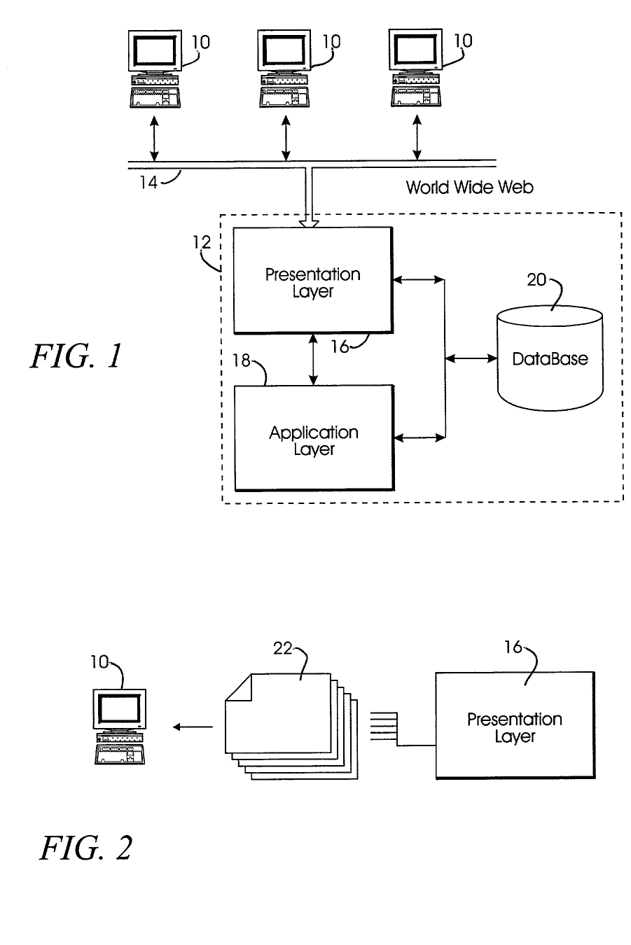

Turning now to FIG. 1, there is shown in semi-schematic partial block diagram form, the major components of a network-based data processing system, suitable for implementing the features of the trading platform of the present invention. As mentioned previously, the system is network-based, in that a number of individual users might be able to connect to the system and access the functionality of the system through individual user access devices 10, such as a personal computer. User devices 10 are coupled to a central data base server system 12 by a network communication link 14. The network communication line 14 used to communicate with the server 12 might be implemented in the form of a modem, which transfers information over a public telephone lines, or a cable modem, wireless communication link, fiber optic line, or the like, but preferably represents a global communication link, commonly referred to as the World Wide Web, itself accessible per the previously mentioned modems, cable modems, and the like. It should be noted that the specific method by which user devices 10 communicate with the server system 12 is not particularly important to the context of the invention, so long as the type and scope of information which will be described in greater detail below is able to be transferred between the server system 12 and the user devices 10.

It should be evident to those having skill in the art, that although the server system 12 has been described, in connection with the exemplary embodiment to FIG. 1, as a central server system, it might also be implemented as a distributed server system, with various pieces of functionality hosted on and supported by various different servers that need not be co-located. It should also be evident to those having skill in the art that the user device 10 need not necessarily be a personal computer, but might instead represent any form of device capable of interfacing between a user and the, for example, World Wide Web. Other examples of such devices that would be contemplated within the scope of the invention would include hand-held or palm-top computers, WAP enabled wireless devices with a sufficiently large display area, an interactive Web TV, or the like. The actual form of the user device 10 is not particularly important in the context of the invention, so long as the user device is able to receive the type and scope of information, which will be described in further detail below, from the server system 12.

In accordance with the invention, the server system 12 is provided so as to allow users to effect procurement, marketing and distribution transactions with one another, as well as to allow for the management of this trading activity and of the trading platform as a whole. For example, when a buyer prepares a bid order for a particular good or service, this order is transferred from the buyer's device to the server system 12 through a presentation layer 16. Presentation layer 16 is implemented as a set of user accessible screens having data entry and data delivery fields arranged in a fashion so as to ease trading activity. The buyer's bid order is processed by an application layer 18, implemented as an application software program which functions, in a manner to be described in greater detail below, as the central trading platform engine of the invention. Application layer 18 processes the bid and posts it, again through the presentation layer 16, to an aggregate data screen which is accessible to all of the users registered with the trading platform.

In like manner, a commodity seller might develop an ask order, sometimes referred to as a request for quote or RFQ, for particular commodities which they wish to sell, and transfers the ask order or RFQ over the communication link 14 to the server system's application layer 18, through a corresponding data entry screen provided by the presentation layer 16. The ask order is then processed by the application layer 18 and posted to an aggregate data screen implemented through the presentation layer 16, once it is accessible to all of the users who registered with the trading platform system.

In addition to presentation and application layers, the system of the invention further includes a data base 20 which might be implemented as a monolithic data base, or which might also be implemented as a multiplicity of smaller, case-specific data bases, for data storage and retrieval purposes. Data base 20 is particularly suitable for developing and maintaining statistical data regarding pricing trends, market movement parameters, the effects of weather and other various demographic pressures on both supply and demand, all of which would be made available to registered buyers, registered sellers, and registered market analysts, in order that such trend data might make the particular commodity marketplace more efficient on a long-term basis. The database 20 also includes a set of extrinsic metrics or parameters that, in a manner to be described in greater detail below, are extremely useful in assignment certain geographic ranges, or other pre-determined practical constraints, to various transactions. Such practical constraints might include an effective transaction range for perishable item transactions, for example, or in the establishment of partner relationships in the case of buyers and sellers who are intimately familiar with one another and do not wish to transact with unknown third parties.

In like manner to the user device 10, the server 12 is depicted in the exemplary embodiment of FIG. 1, as a single device, but need not be so implemented. The server 12 might be composed of several computing units which might also typically contain corresponding external storage units, communication interfaces for transferring data between and among the users as well as other servers, processors, and memory subsystems, and other computing devices that are commonly associated with server systems. In addition, a number of servers might be distributed in various different geographical locations, with each server forming a local nexus for a local commodity marketplace, in order to make such local markets more efficient. The advantages of a distributed server system become apparent when it is recognized that buyers and sellers are able to interact with the trading platform on a continental and indeed global basis, with sellers in, for example, California and Connecticut both marketing their goods and services to a universe of purchasers that might include buyers in Alaska, Texas, Peru or Germany. Local distributed servers allow the trading platform to be implemented in a quasi-star configuration, with each local nexus communicating with all other local servers, so as to aggregate all of the data, allow for cross-border purchases and shipments, while more directly servicing local commodity markets.

Turning now to FIG. 2, there is illustrated in semi-schematic partial block diagram form, a detail of how the system's presentation layer 16 might interact with particular user interface device 10. Briefly, the presentation layer 16 is composed of a number of particular, purpose-built graphic display screens, generally indicated at 22, each of which are particularly devised to either present or receive application specific data. Presentation layer 16 is implemented as a number of graphic screens 22, since the presentation layer must be able to communicate with buyers, sellers, transporters and financial institutions, as well as be able to present commodity trading data to the entire universe of users. The graphical display screens 22 are necessarily controlled by a display engine within the presentation layer 16 which invokes particular ones of the display screens depending on individualized choices of a particular user. Since the system is contemplated as being Internet based, one of the screens, i.e., an entry level screen or a top-level screen, might be the trading platform's home page, from whence a user might navigate through the system in an efficient manner. Other pages might be individualized for displaying or receiving buyer specific data, such as desired prices and quantities for particular types of commodities, while other pages might be individualized for a seller's purposes, such as presenting or receiving data regarding a desired sale price and a quantity. A further screen, or set of screens, may not be particularly individualized for either a buyer or a seller, but might rather be directed towards presenting or receiving data relating to an aggregate or universe of trading transactions, and specifically for presenting such information in a unique, visually interactive form.

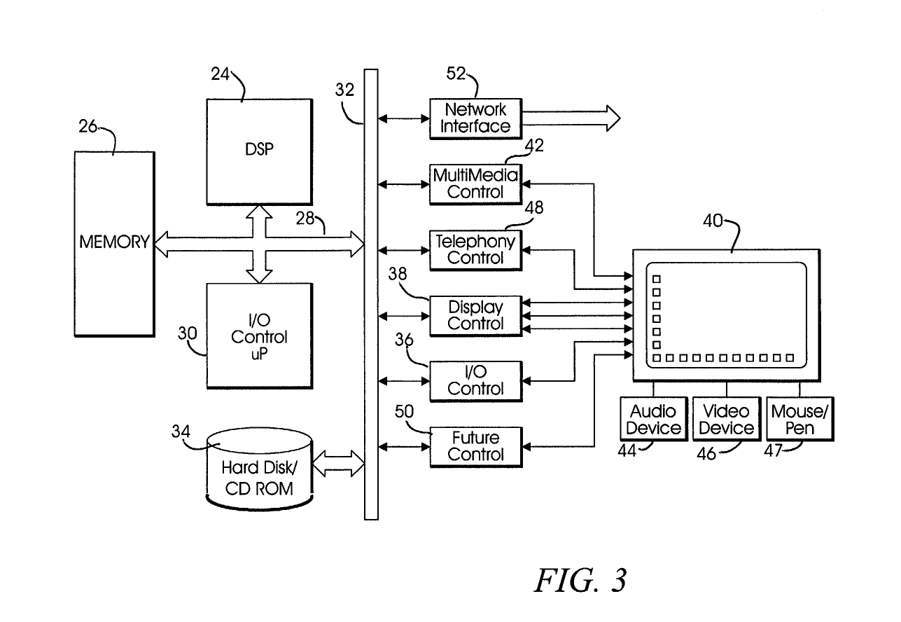

Before discussing the operational details of the system and the methods in the present dimension, it will be useful to describe the type or types of user interface devices (10 of FIGS. 1 and 2) that are particularly suited to interface with the exemplary trading platform system. A generalized, block-diagram of such a user interface is illustrated in FIG. 3 and is indicated generally at 10. The user interface device 10 is configured as a desk top or lap top-type personal computer system and is capable of executing an application software routine, such as a net browser program, as well as incorporating various I/O interface devices so as to be able to communicate in accordance with whatever communication link is established between the user device 10 and the exemplary system's server (12 of FIG. 1). The user device 10 suitably includes a control processor 24 which might be a digital signal processor, a commercial general purpose microprocessor or a purpose-built processor, capable of executing instructions provided as an application software routine. The system 10 further includes memory 26, such as RAM, ROM, EEPROM, and the like, which functions to store the system's operational programming as well as providing temporary storage for data being transferred to and/or from a network server system. The microprocessor 24 and memory 26 are coupled together over an internal bus 28 which is further coupled to an I/O control processor 30 which operates the various interface and peripheral devices which enable the system 10 to communicate with the outside world.

Thus, the processor 24 fetches, decodes and executes computer readable instructions and transfers information between other system resources over the main system bus 28 and a peripheral bus 32. Peripheral bus 32 typically interconnects with the various peripheral components in the data processing system and further defines the particular protocol used for data exchange. An example of such a bus is the Peripheral Component Interconnect (PCI) bus. A hard disk drive or CD ROM drive 34 is often coupled to the system over peripheral bus 32 and offers the system the capability of large-scale data storage. Access to the hard disk or CD ROM drive 34 may be controlled by an I/O control circuit 36 that directs and controls reading information from and writing information to any of the various storage media that might be implemented within the system. In addition to I/O control 36, the system might further include a display control circuit 38 (i.e., a video card) that determines how information is arranged on a visual display screen 40. The multi media controller 42 might also be coupled between the peripheral bus 32 and a system display unit 44 in order to give the material being presented to the user the added dimensions of sound and motion. In this regard, an audio device (or devices) 44 might be coupled to the system and parallel to the system display 40. The audio device 44 might be implemented in the combination of a microphone and speakers, such that it can receive an audio input from the user through the microphone and deliver audio contact to the user over the speakers. A video device 46 might further be implemented as a camera which receives moving visual images from the user which are subsequently processed by the multi media controller 42 for transmission over the network, for example.

In keeping with this communication capability, the system might further include a telephony controller 48, which might be implemented as a Voice Over IP (VOIP) interface circuit for implementing telephonic communication over the Internet, or it might be implemented simply as a local POTS or PBX telephonic interface circuit. In this regard, telephony control 48 and multi media control 42 are not necessarily mutually exclusive operational modes. Depending on how a user is using the system 10, band width constraints might require that the user effect communications using a telephony application at certain times, while the availability of a high band width network connection may allow a user to engage in a multi media communication mode at other times. Having both communication modalities available in a particular device, while not necessary for practice of the present invention, would be advantageous to those users whose livelihood depends upon maintaining at least a modicum of communication with trading partners during the trading seasons.

Because the system 10 is implemented as a personal computer (whether desk top, lap top, palm top, or the like), it will be evident to those having skill in the art that other interface and/or communication methodologies may be incorporated into the system, on a modular basis, as those communication methodologies are developed and commercialized. For example, as wireless technology becomes more pervasive, it is certainly expected that it will be incorporated into the next generation of computer systems. Accordingly, if future interface controller 50 is expressly incorporated into the exemplary system 10, and is contemplated as supporting any one of a number of future communication/interface modalities.

Any or all of the aforementioned communication/interface control devices are easily coupled to a modern computer system through its peripheral bus 32 in the form of either expansion cards or functional circuit boards. Typically, an expansion card or circuit board comprises a circuit board hosting integrated circuit chips and other electronic components, it adds functionality or resources to a computer system in expandable fashion. The lap top, palm top and/or other portable computers, expansion cards typically take the form of PC cards which are credit card-size devices designed to plug into a slot or receptacle provided for such purpose from the side or back of such computer system. A particular example of such an expansion card is the PCMCIA (Personal Computer Memory Card International Association) card.

In order for the system 10 to communicate with a server or servers which implement the trading platform, a network interface device 52 is provided which is also coupled to the peripheral bus 32. Network interface device 52 allows the system 10 to communicate with other devices coupled to a particular network in accordance with that particular network's information exchange protocol. For example, the network interface device 52 might be a 100 BASE-T Ethernet transceiver, if the physical communication media between devices were an unshielded, twisted pair of wiring plant. Alternatively, the network interface device 52 might implement wireless communication protocols such as Bluetooth, might implement cable modem circuitry, and the like. It should, therefore, be understood that the specific form and functionality of the network interface device 52 is not particularly important in the scope and spirit of the invention. All that is required is that a user system 10 have some means of accessing and communicating with a server or servers hosting the novel trading platform, over some form of local or wide area network, such as the World Wide Web.

Although the particular form and architecture of the user system 10 described in connection with the exemplary embodiment of FIG. 3, does not represent any particular requirement for practice of principles in the invention, there are certain minimum and recommended computer hardware and software system implementations that would be particularly advantageous to a user of the trading platform according to the invention. For example, in a personal computer (PC) environment, a user would be well advised to implement a PC with Windows 95 or a later model operating system, running on an Intel Pentium II processor. 16 MB of random-access memory (RAM) is suggested, while 64 MB of RAM is preferred. The display should be implemented as a color monitor set at least 800×600 pixel resolution, for best results when the system is used in conjunction with the graphical interface screens comprising the novel system's presentation layer, as will be described in greater detail below. For communication and interface with the Internet, the system requires some sort of web browser software program, with either Microsoft Internet Explorer or Netscape Navigator web browser software being recommended.

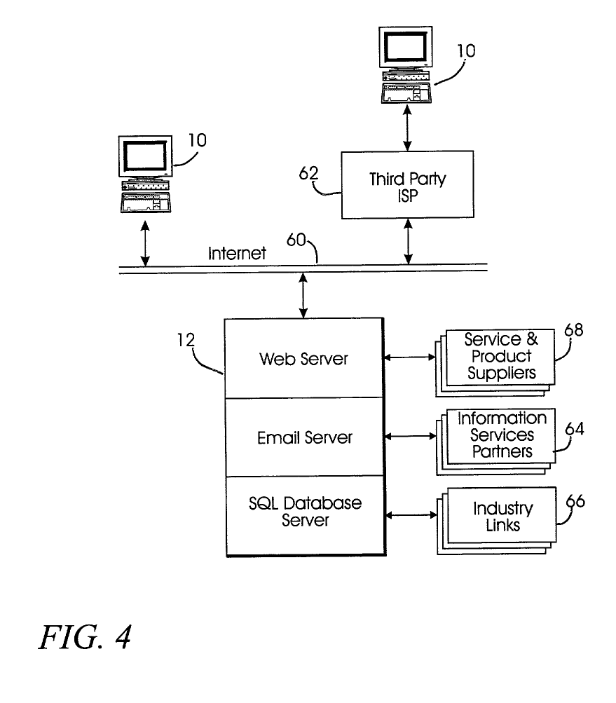

In like manner, it will be useful to discuss some of the features and aspects of a server system (12 FIGS. 1 and 2) that are particularly suited for implementing the trading platform in accordance with the invention. A generalized, block level diagram of such a system is illustrated in the exemplary embodiment of FIG. 4, and is illustrated generally at 12. In addition to the server system 12, the exemplary embodiment of FIG. 4 also illustrates an exemplary user interface device 10 as a thin client device implemented as a web browser, coupled to a wide area network such as the Internet 60 through a third-party ISP 62 or by direct connection. The server system 12 is coupled to the wide area network 60 through a corresponding direct connection and might be viewed as comprising a multiplicity of functional servers, each of which communicate with a user in accordance with a standardized interface protocol. The server system 12 might include a web server, an e-mail server, and an SQL data base server, the combination of which facilitate on-line browsing and trading by a user, customer service, technical support, corporate information and demonstrations/previews. The particular manner in which web servers, e-mail servers and SQL data base servers are facilitated and implemented are well known to those having skill in the art, and require no further discussion herein. However, these particular functional features are advantageous in the context of the invention, since they allow, not only on-line interactivity through a browser, but also provide for real-time adaptive communication between and among users as well as between users and the system 12.

In the exemplary embodiment of FIG. 4, the server system 12 is also enabled to communicate with various other entities that might not be characterized as users of the trading platform. Such other entities might include information services partners such as weather or news content sources, geographic and demographic information providers, and the like. Certain other third-party information providers might include various industry-related organizations 66 which could provide web links to their organizational services, which links would be accessible through the trading platform of the invention. Examples of such industry-related organizations might include the California Farm Bureau, in the case of California agricultural products, the American Association of Chemical Manufacturers, but in the case of chemical commodities, and the like. Further, certain service and product suppliers 68, adjunct to the particular commodities offered over the trading platform, might also provide web links to their services, for access by a user through the server system 12 hosting the trading platform. In summary, the trading platform is contemplated as comprising a fully functional nexus between buyers and sellers of various products, services and commodities as well as between actual trading partners and other information sources that provide data that can inform a transaction decision.

Although the adjunct information providers 64, 66 and 68 are depicted in the exemplary embodiment of FIG. 4 as forming a part of the observer 12, it is certainly within contemplation of the invention that the information or content provided by these adjunct providers could be merely pointed to, using HTML script, or the like, by a link list hosted on the web server portion of the trading platform server 12. In other words, third-party content could be hosted by the server or merely pointed to by the server, without effect on the scope and spirit of the invention.

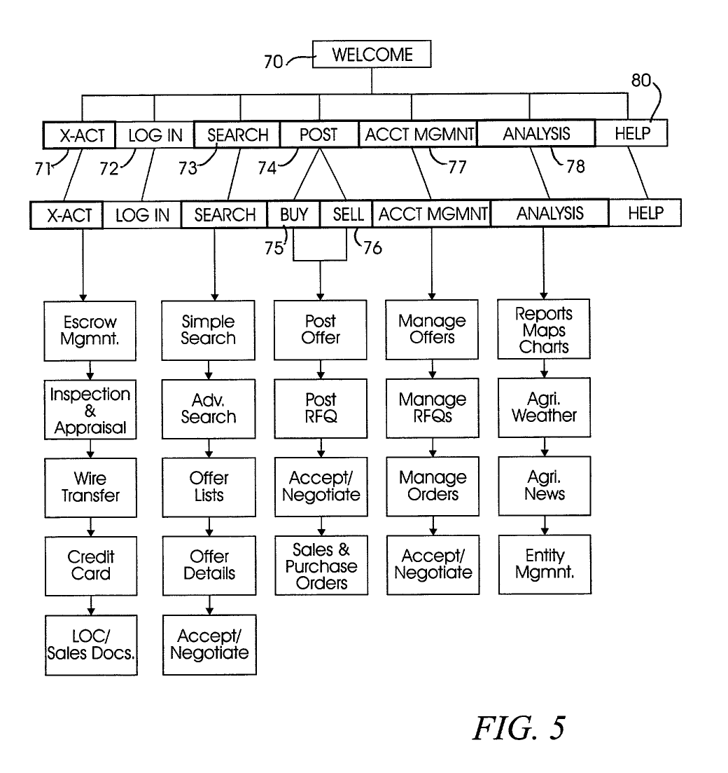

The operation and functionality of the trading platform in accordance with the present invention will now be described in connection with the semi-schematic block level interface structure diagram of FIG. 5. Before entering into a detailed discussion of the exemplary embodiment of FIG. 5, it should be noted that the system according to the invention is made intelligent to a user by presenting certain forms of information to the user in the form of various information presentation and data entry screens. The form and arrangement of each of the data entry screens is a function of the system's presentation layer and will be described in greater detail below. However, and in accordance with the invention, the various screens are arranged into functional groupings that conform with the major functional elements of the system, as defined by the system's application layer.

Accordingly, the various block elements of the exemplary embodiment of FIG. 5, represent both the system's internal presentation arrangement as defined by the presentation layer, and the system's functional arrangement as defined by various functional engines residing within the system's application layer. Since the invention is cast in the form of a network application, it will be evidence that invoking the application brings the user to the system's home page, i.e., the application's top-level informational service screen which might also be characterized as a “welcome” interface 70.

As the welcome screen appears, the user is given certain functional options to pursue, depending upon whether or not the user has an account with the trading platform. The various options available to a user are expressed, in the exemplary embodiment of FIG. 5, as functional blocks subtending from the welcome block 70. As well as representing functional options, the functional blocks might be arranged on the welcome screen 70 as menu items or button bars, such that the user need only access a functional item in order to invoke the corresponding function engine defined by the system's application layer.

For example, after the user enters the system, the user may choose between and among various trading activities, including financial transaction activities 71, logging in 72, searching 73, posting 74, managing their account 75, obtaining market analysis results 76 and help 77. In accordance with the invention, these functional groupings allow a user to quickly and efficiently search through the market data base for outstanding offers to sell (from growers, vendors, shippers and contractors, for example) or offers to buy (also expressed as requests for quotes) from a wide range of purchasers. The two halves of the marketplace are graphically presented to a user in a form and structure that allows the user to immediately grasp the scope and state of a desired market and identify outstanding offers (whether to sell or to buy) that are of immediate interest to their business.

Invoking the search function 73 puts the user into a secure area through which the system's search functionality is interacted with by the user. As will be described in greater detail below, the user may elect to perform a simple search or a more advanced search for pertinent market offers. Once search results have been obtained, various offers are presented in the form of lists from which a user might obtain additional, offer specific, details which allow the user to inform their transaction decisions. Depending upon the details of each offer, a user might elect to either accept the offer as it stands, or perhaps to negotiate with the offeror over certain terms and condition of the offer. All of this functionality is driven by a search engine which forms part of the system's application layer. Each of the functional elements within the search area are interacted with by a user in accordance with data presentation and entry screens generated by the system's presentation layer.

In addition to searching, a user is able to post offers to buy or sell a commodity, product, service or transportation contract, to the system's database, thereby making those offers available to a subsequent search. The post functionality 74 might be thought of as being bifurcated into buying functionality 75 and selling functionality 76. Since posting 74 can be accomplished by either side of a transaction, the exemplary embodiment of FIG. 5 sets forth the posting functionality in two forms: a first form in which posting 74 is provided as a unitary function, and a second option in which posting 74 is explicitly bifurcated into a buy function 75 and a sell function 76. It should be noted that bifurcation could be accomplished at the top-level of the system's architecture with separate buy and sell buttons on a menu bar, or in the case of a unitary post button on the menu bar, buy and sell functionality could be independently accessed once the user has invoked post.

Regardless of how implemented, the post functionality 74 allows a user to enter a secure area in which they are able to post offers to sell, requests for quotes, accept outstanding offers or negotiate modifications to outstanding offers. Posting offers or RFQs (also termed preparing transaction offer notices) involves preparing a set of data entry records, presented on a posting screen, with the various data entry fields being adaptively configured to request certain forms of information depending on what type of entity is posting an offer or RFQ. An agricultural commodity producer will necessarily wish to provide certain forms of information regarding their commodity that would not necessarily be applicable to an offer to sell agricultural chemicals, for example, by an agricultural product manufacturer. Offer and RFQ data entry records are therefore slightly different for each of the four general, top-level categories, i.e., commodities, products, services and transportation, which define the categorical hierarchical structure of the system's informational database.

At this juncture, it will be advantageous to mention that as a new user establishes an account with the system, they are required to establish a user profile which includes demographic and geographic information relating to the entity, as well as specifying the entity type. Entity type is a required field in the user profile and is contemplated as setting forth whether the entity is a commodity grower/producer, a product vendor, a services contractor/vendor or a transportation shipper. It should be noted that each of these various entity type categories corresponds to the four general top-level market categories which define the hierarchical categorical organization of the system's database. Thus, entities are identified to corresponding sets of marketplace items, such that a trading activity (represented by a trading activity screen) can be undertaken with respect to an informational structure that contains item characteristics pertinent to the types of items dealt with by that entity. In this particular manner, the trading platform, in accordance with the invention, integrates relevant data across all of its functional services, with the data being pertinent to the specific item being traded. Although data records might be slightly different, depending on entity type and the item being traded, the trading flow is standardized with respect to all of the trading processes, irrespective of entity type or the transaction nexus.

Account management functionality 77 is also implemented in a secure area of the system and is accessed by perhaps depressing an account management button on the system's menu bar. The account management functionality allows a user to view, manage and/or modify all of the various activities which the system undertakes with respect to their entity account. Trading platform members are able to manage their offers to sell, both outstanding offers and historical offers, manage their RFQs in the same fashion, manage their sales and purchaser orders and participate in ongoing transaction negotiations up to and including acceptance.

An analysis section 78 gives a member the opportunity to utilize the power of the system's database in order to generate real-time market analysis reports, as well as graphical presentations of various important item metrics, such as supply/demand “hot spot” maps, price trend charts, and the like. From within the analysis section 78, a member is also able to obtain information related to agricultural weather forecasts, for example, agricultural news, currency conversions, and the like, by having the system either provide a link to partner web sites that contain such information, or by having the system acquire such information and present it to the user in a frame, pop-up window, or the like.

Given the scope and extent of the information maintained by the system's database, member entities are able to utilize this information in order to manage their business on an on-going basis. Entity management tools allow agricultural producers, for example, to plan crop rotations, harvesting schedules, and the like. Agricultural product manufacturers can plan just-in-time production activities and inventory levels, so as to mitigate the seasonal, cyclical nature of the agricultural business.

A further functional area, defined by the system's application layer, relates to the financial transactions that must be undertaken at the end of trading activity. Once goods or services are contracted for, the purchaser enters the transaction area 71 from which they are able to pay for goods in accordance with payment terms that have been mutually agreed upon. For example, mutually agreed upon terms and conditions might be transferred to an escrow agency which arranges for the transfer of funds to the producer or vendor, upon the occurrence of certain escrow conditions. Once the escrow conditions are met, funds are transferred and the transaction is complete. Alternatively, a purchaser might arrange for a wire transfer of funds, either through their own financial institution, or through a financial institution partnered with the trading platform and whose services are available by electronic link through the platform's application layer. Similarly, credit card payment might be made either through a purchaser's own financial institution or through a secure server credit card transaction engine hosted by the trading platform.

Since, as has been mentioned above, transaction data is integrated to cross all of the system's services, all of the pertinent details regarding a particular transaction are available in an electronic sales and/or purchaser order, which can be electronically transferred to a third-party institution. In this manner, either party to a transaction can provide pertinent data to a corresponding institution, if item inspection and/or appraisal is one of the terms and conditions of a sale. Likewise, the system can electronically provide all of the requisite data necessary for one of the parties to the transaction to obtain letters of credit or sales documents, if those are customary activities in the relevant marketplace. Any and all forms of third-party institutions are able to partner with the trading platform, such that any of the activities represented by the financial transaction functionality 71 can be undertaken by merely following a link to the desired institution or by merely requesting a particular service, such as a wire transfer, with a link to the appropriate institution being automatically established.

As shown in the exemplary embodiment of FIG. 5, the financial transaction area 71, search are 73, post area 74, account management area 77 and analysis area 78 are secure areas within the system, such that entities not members of the trading platform are unable to avail themselves of the functionality represented by those areas. As a new user interacts with the system's home page (welcome screen 70) they are only able to access a log-in area 72 or a help area 80. Necessarily, the log-in area 72 overlays the other functional areas of the system, such that if a member enters the system and proceeds immediately to either the search area 73 or account management area 77, they will be able to access those areas only by passing through a log-in procedure.

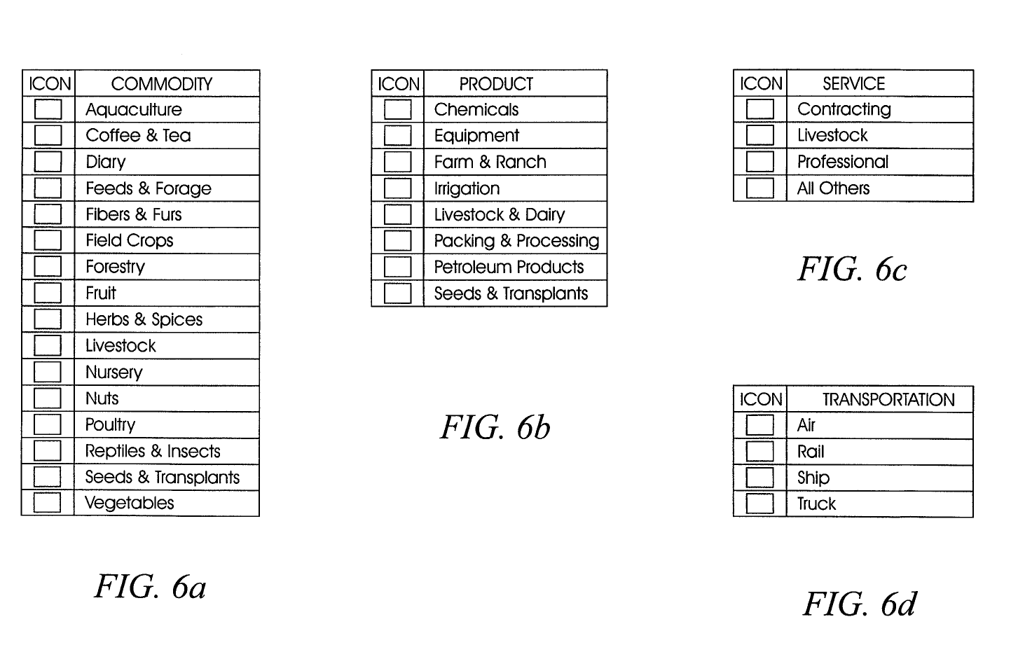

The trading platform, in accordance with the invention, enables members to search, post and negotiate transaction notices, such as offers to sell and requests for quote (offers to buy) for several types of goods and services, within particular market groupings, which define a general agricultural marketplace, the market groupings ranging from agricultural commodities to transportation, and including farm-related products and services. The manner in which transactional activities are conducted, are coordinated in accordance with these four general, top-level market categories, i.e., commodities, products, services and transportation. The various functions of the trading platform, i.e., searching, buying, selling, negotiating, and the like, are also accessed in accordance with these four general top-level market categories (also termed top-level categories or top-level markets). Additionally, and in a further aspect of the invention, each of the top-level categories are further broken down into market segments (also termed element categories herein), themselves further subdivided into segment subcategories (or item categories) and item type (where applicable). For example, in the case of the top-level market category “commodities”, there are 16 major market segments of commodities, ranging from aquaculture to vegetables. The particular elemental categorical organization of the top-level commodity category is illustrated in the list table of FIG. 6a. From the elements comprising the exemplary list, it is understood that the top-level category “commodity” represents various commodities that might be available in an agricultural marketplace, with the elemental categories contained within representing the various aspects, fields and/or segments of agricultural commodities into which products might be organized.

Further, and in keeping with the organizational concepts related above, each of the elemental categories identified in the exemplary list of FIG. 6a, are further broken down into subcategories that each identify a particular set of items that make up a market segment of an elemental category. For example, the elemental category Fruit might be further divided into subcategories denoted as oranges, apples, grapes, and the like, while the elemental category Livestock might be organized into subcategories representing dairy cattle, beef cattle, hogs, horses and the like.

Similarly, and as depicted in the exemplary elemental categorical list of FIG. 6b, the “product” market category might be divided into 8 major elemental market segment categories of the agricultural products market, ranging from Chemicals to Seeds and Transplants which are available for members to buy and sell using the trading platform. In a manner similar to the hierarchical organization of the commodity top-level category, the product top-level category has its elemental categories further subdivided into subcategories that relate to particular aspects of the market for each of the elemental categories. The Irrigation elemental category might be subdivided into subcategories such as pipes, pumps, filters, and the like, while the Seeds and Transplants elemental category might be understood to be subdivided into subcategories such as seed corn, grape root stock, alpha sprouts, and the like.

In like fashion, agricultural services and transportation top-level market categories are further defined in accordance with numerous available elemental market segment categories, subcategories and types. This particular hierarchical organization enable members to be very specific in describing the commodity, product, service or transportation mode that they are selling, buying or wishing to search for. It should be noted, that the transportation top-level category is divided into four major elemental market segment categories of transport, i.e., air, rail, ship and truck. Because of the nature of transport contracting, these four elemental categories are not further broken down into subcategory and type, but rather, the hierarchical organization jumps directly from the elemental category to a type designator, in which a transportation contractor can enter various special transportation mode requests, as will be described in greater detail below. Transportation is almost always a customized activity, with various commodities and products requiring different transport modes, given the extreme range of parish ability metrics commonly associated with agricultural-type products. Certain commodities and products require refrigeration and are unable to be transported over any great distance. Other commodities and products (particularly dry, bulk products) can be stored for an indeterminate amount of time and are able to be shipped long distances without suffering any time or transportation related degradation and quality characteristics.

However, even though transportation is not subdivided into as finally grained a set of categorical levels, this is done primarily for reasons of efficiency. It should be understood that the elemental categories could further be subdivided into subcategories including further type designators at the option of the system designer. The particular manner in which the goods and services supported by the trading platform are organized into rational hierarchies is not particularly important to practice the principles in the invention. What is important, however, is that the collection of goods and services be organized into rationally related groups, with a certain degree of increasing particularity as user traverses a group, such that goods and services can be easily identified with respect to a purchase, sale or transport transaction.

The particular organization of trading platform information into a structure defined by markets, and further divided into respective market segments, themselves divided into items, is a particularly advantageous feature of the system of the present invention. This structure allows information to stored in a database in a form that allows for easy accessibility by a user, even though the user has little or no familiarity with the entire scope and extent of an agriculture related marketplace.

Organizing the collection of goods and services into a hierarchical categorical structure is important because, as will be described in greater detail below, purchase and sales transactions, as well as searching, are all performed in accordance with the hierarchy. Elements that are contained within the systems' database such as transactions, and the like, are allocated into groupings in accordance with the categorical hierarchy. Thus, any transactions relating to Livestock, Commodities will be contained within the Commodities top-level category and will be allocated to the Livestock elemental category. Searching through such a categorical hierarchical structure is relatively simple, even for those users who do not have a great deal of facility with computer systems.

Operationally, use of the system begins with a user's accessing the trading platforms' home page and, if not already a member or subscriber to the trading platform, acquiring a membership or subscription to the system logging in. Further, a member must log in to the trading platform before entering any of the secure areas of the system such as the search, post, account management and member directory sections. Because the search area contains information on active offers for various commodities, products, services and transportation, only trading platform members are able to access this information. Similarly only trading platform members are able to access the post section, where offers to sell and offers to buy are posted, as well as the membership account section which contains company member account information. When a member initially accesses one of these secure areas, a login screen is displayed which prompts the member for their user name and password. Once a member has logged into any one of these secure areas, they are able to access the others without any further login activity.

Where a user is not a member, the home screen allows a new user to access the “account management” functionality which, so long as the user has not logged in, defaults to a transaction management area which gives the user the option to choose a “membership” link and establish an account. The membership link accesses a new user data record and requires the new user to fill in certain data entry fields with necessary demographic and business information. These data entry fields naturally include the users name, business, address and contact information, and might also include an indication as to whether this user (personal or company) is a buyer, vendor, producer or shipper. This last categorical differentiation allows particular types of information to be adaptively processed and presented to particular users, based upon their primarily interaction with the trading platform, primarily selling, primarily buying or primarily transporting.

After the new user data record is complete, the new user is assigned a password and is now ready to begin utilizing the system. After log in, the user is able to access any of the aforementioned secure areas, in which system functionality is accomplished. The user is able to search for transactions, post an offer to buy, post an offer to sell, review their account, etc.

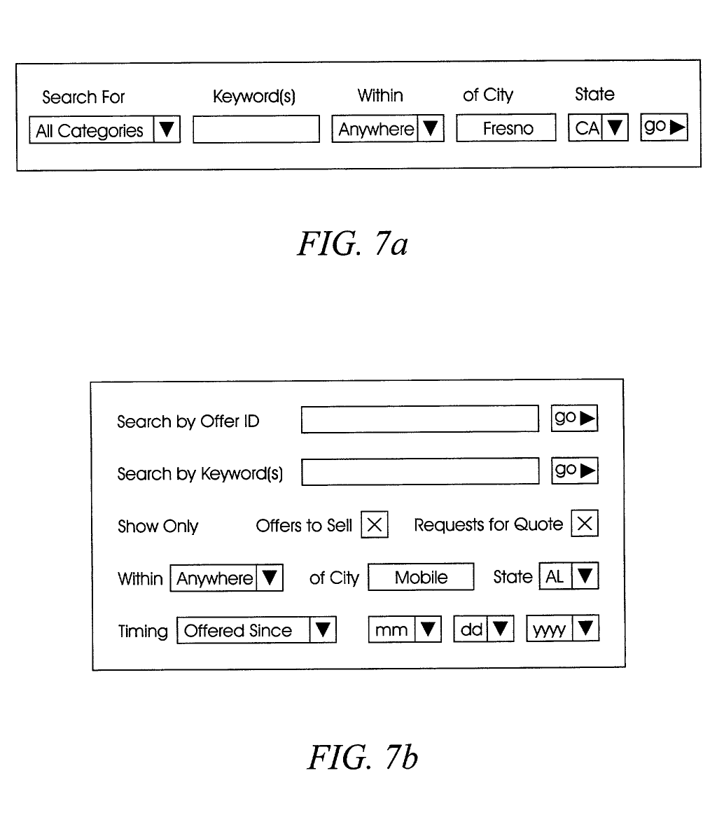

In the context of the search area, the trading platform enables members to search the data base for active offers to sell and requests for quote (offers to buy) for diverse farm production commodities, agricultural products and services and truck, rail, ship or air transportation. Commodities, products or services can be searched for by category and location, while transportation can be searched for by type and location, as will be described in greater detail below. When an active offer is located that meets the search criteria, negotiations between a buyer and seller, or a shipper and carrier, can take place. If there are no active offers meeting a memberships' search criteria for a particular commodity, product, service or transportation, the member is able to post either a request for a quote or an offer to sell. The trading platform database can be searched using one of two methods; a simple search methodology or an advanced search methodology. In the case of a simple search, the member accesses the “search” area on the platforms' menu bar wherein the presentation layer displays a default simple search screen which is illustrated in FIG. 7a. The search screen is divided into five data entry fields, three of which are cascade menu driven; a “search for” field, a “key word” field, a “within” field, a “city” field and a “state” field. The “search for” field is menu driven, in that the hierarchical categorical organization of the database is represented within a set of cascading menus, such that a user might easily develop which top-level category, elemental category and subcategory they have an interest in. In addition to a categorical search field, the simple search frame represented by the exemplary embodiment of FIG. 7a includes key word searching capability, in which a key word data entry field might be filled with any particular key word or key words associated with the product type specific to the user requirements. Since the trading platform is global (continental at the very least) in nature, a user might wish to limit their searching to vendors or buyers within a certain radius of the users' location. Accordingly, a further set of data fields allows the user to identify a geographical radius within which the search is to be conducted. The user might search for offers to sell or requests for quote “within” a radius, i.e., 5 miles, 10 miles, 100 miles, or defaulting to anywhere, of a “city” within a “state”. Once the user has identified the search parameters, a “go” button launches the search of the database for offers to sell or requests for quote that satisfy the users' search criteria.

Optionally, a user might request an advanced search, which provides additional filters for information returned from the database. In the exemplary embodiment of FIG. 7e, an exemplary advanced search screen is populated with data fields such as “search by record ID” which initiates a search for transactions identified by an identification number, or “search by key word” which initiates a search of the database in a manner described in connection with a simple search above. In addition to these data entry fields, the user is able to select various filters for returned results. The user might, for example, set a filter to show only either offers to sell or requests for quote, by indicating their preference in a selection box. The user is further able to specify that transactions be shown that only occur within a particular radius of a particular city and state.

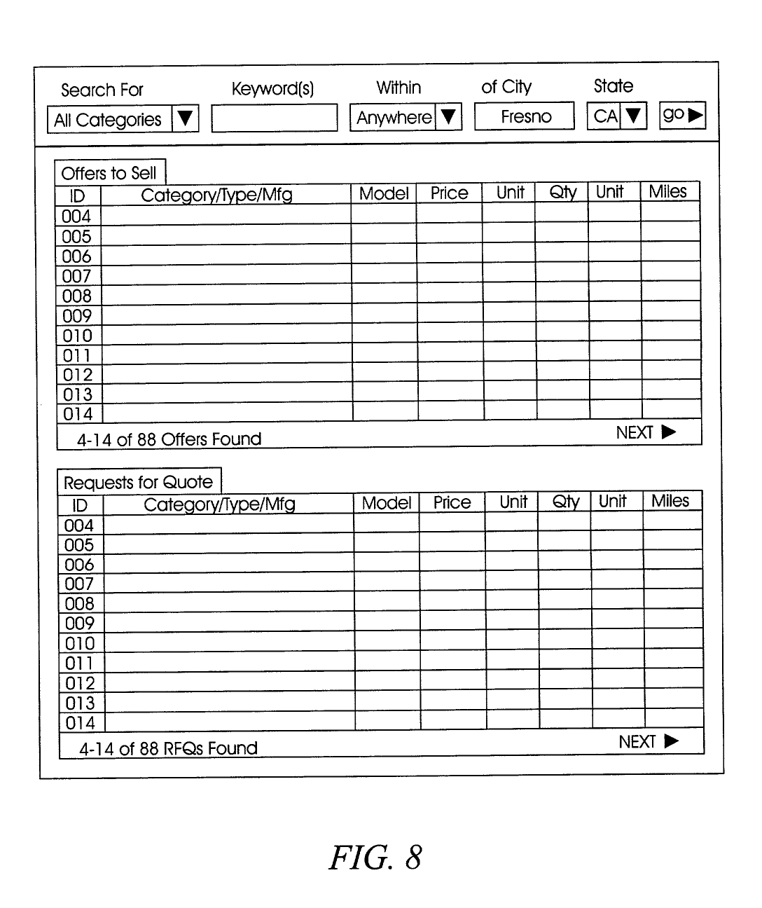

A timing option is also offered in the advanced search whereby a user is able to select either “offered since” or “available staring” from a drop-down list and is further able to select the data from additional drop-down lists in order to search for commodities, products or services offered since or available starting with the date specified. After all of the search criteria are defined, the user initiates the search by depressing a “go” button which returns a search result list, illustrated in FIG. 8, with simultaneous displays of offers to sell and/or requests for quotes that satisfy the search criteria.

FIG. 8 is an exemplary screen shot of the search screen, after a search has been conducted and results returned to the user. The search results are presented in split-screen fashion, with the top portion of the results screen containing offers to sell that match the search criteria; the bottom portion containing requests for quote satisfying the search criteria. Necessarily, if the user has elected to have the system show only offers to sell, the bottom portion of the screen will not show requests for quote; the offers to sell returned by the search will populate the entire screen.

In the exemplary embodiment of FIG. 8, the offers to sell and requests for quote are delineated as horizontal items, with each item comprising an item ID, which might also be associated with a representative icon. The items subcategory, type or manufacturer/variety are listed next to the item ID. If available, a model number is given along with the items' price, the unit upon which the price is based, the quantity (either offered for sale or desired to purchase) and the unit upon which that quantity is based. A further field indicates the geographical radius within which that particular offer to sell or request for quote is located. Thus, a user is able to determine that although a particular offer to sell appears reasonable, it might be located at too far a distance to make that transaction economic. Accordingly, the user might wish to avail themselves of a slightly more expensive transaction which is located within a radius that might reduce shipping costs in order to make that transaction more desirable.

Further, and in accordance with the invention, if the user wishes to view the details of a particular offer (whether to sell or to buy) the user need only access the details of that offer by “clicking” on the ID number associated with that offer. Offer details contain certain information which is provided by the poster of that particular offer and would include further terms and conditions and other transaction metrics that would be of interest to a user. Selecting the details of an offer accesses an offer detail screen that contains other specific data related to the transaction, such as more detailed type information, model number, size, SKU number (where applicable), a product description, weight indicia, the identity of the poster and specifics as to the transaction location. Other offer details such as offer starting date and time and offer ending date and time are also included in the offer detail record, along with shipment terms, delivery terms, and the like. Thus, from the search area, a user is able to develop a set of search criteria for particular commodities, products, services or transportation in which they might have an interest. Once search conditions are established, the user initiates a search of the systems' database in order to extract all offers to sell or requests for quote, or both, that satisfy the search criteria. Detailed information regarding an offer to sell or a request for quote are obtained from the offer listings that are returned by the search. Thus, a user can very simply and efficiency traverse the system in order to obtain an adaptive and real time impression of the state of a market.

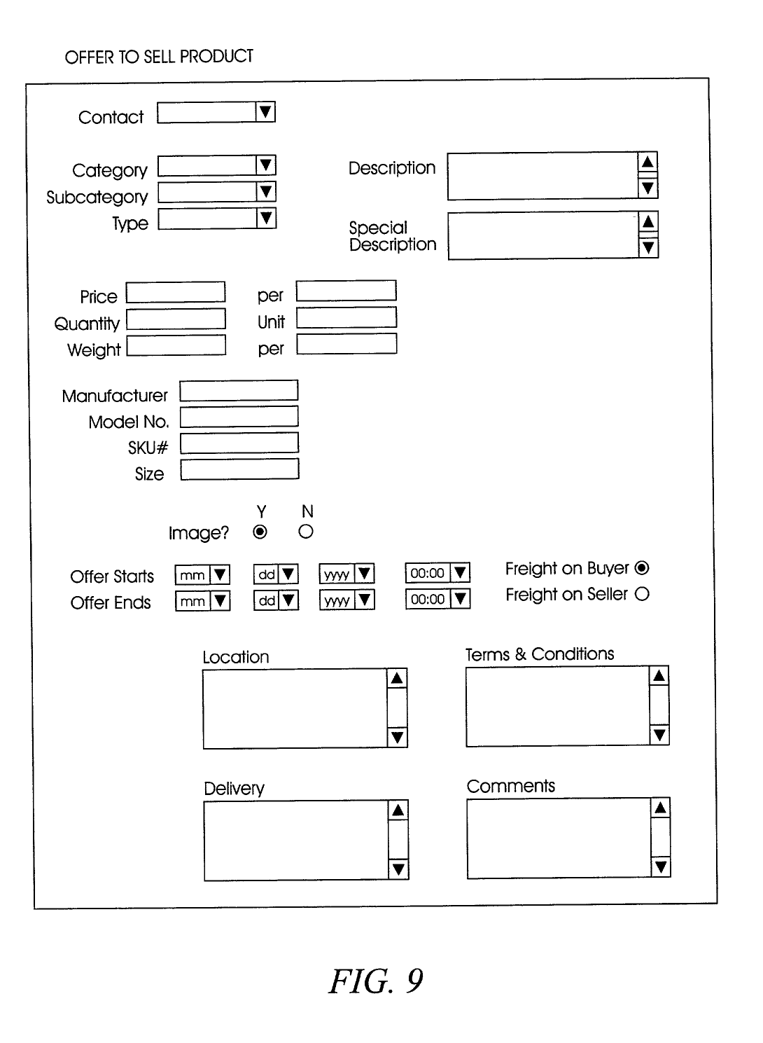

Details of the various offers, whether offers to sell or requests for quote, are entered by various members who might be vendors, agricultural producers, shippers, and the like, when they post either an offer to sell or a request for quote to the system. In order to post a transaction, the user enters either the “buy” or “sell” secure area and fills out a form, containing data record fields, in which details of the offer to either sell or buy are set forth. In the case of an offer to sell, the user might fill out a set of data entry fields arranged on an offer screen in a manner set forth in the exemplary screen shot of FIG. 9. The particular data entry fields might include a contact field which indicates the name or identity of the person or entities to be contacted with respect to the transaction. The contact field might be a keyboard entry field or it might be a drop-down menu driven field with the various menu entries generated by contact data fields in the member profile. Since the member has logged in prior to entering the “buy” or “sell” secure areas, the system is aware of the identity of the member and retrieves contact information data from that members' profile, stored in the database.

Further data record fields allow the member to select the category and/or subcategory of products, services or commodities being offered. The category and subcategory information is again menu driven and is a function of the categorical hierarchical structure of the commodity, product, service and transportation database. A “type” field allows the offeror to enter further categorization indicia in order more distinctly identify the type of good or service being offered. In the case of a product, the offer posting includes such transaction parameters as the item manufacturer, item model number, item SKU number (if applicable), and item size, expressed as data fields into which a user can enter the requisite data in order to further define the specific type of good or service being offered. Price, quantity and weight fields are also provided along with a unit basis for the price, quantity and weight descriptors. A further keyboard entry field, the “description” field allows the user to enter whatever additional textual information they might wish to provide in order to give a complete description of the good or service being offered.

Optionally, the system allows the user to elect whether an image will accompany the offer detail by allowing the user to append a graphical image file to the posting which would be viewable by a user upon selection of an offer detail.

Since many offers are time sensitive, the posting allows a user to set a date and time at which the offer starts, as well as a date and time at which the offer ends. This is particularly important for agricultural producers, since they often wish to offer a particular crop for sale before that crop has been picked. Perishability considerations often require agricultural producers to limit the time during which an offer remains open, i.e., strawberries do not last long after they have been picked. Once the offer details have been established, the user enters the location or locations at which the product is being offer or from which the product will be shipped. Further, the posting screen gives the user the option to select who will be responsible for freight charges by allowing the offeror to select whether it will be “freight on buyer” or “freight on seller”. Further textual descriptor fields are provided that allow a user to set out various other terms and conditions, such as payment options or the like, delivery terms, or comments, that the user feels would be necessary in order to best inform the offer.

Particularly in the case of agricultural producers, an offer to sell posting might also include a set of availability dates, in addition to offer, start and end dates. Certain forms of produce might be available from a particular date and be available to a particular date. In order to satisfy requirements of various agricultural purchasers, the offer posting also includes data fields in which dates may be entered that indicate when a particular agricultural commodity was packed, when it was processed (if applicable) and/or when that commodity was warehoused. Optionally, and in the case of a commodity offer, the offeror has an opportunity to indicate whether the commodity is organic certified by so indicating with “yes” and “no” switches and if so, allows the user to enter the name of the authority in a keyboard entry field.

It should be understood, that the various data entry fields described in connection with FIG. 9 are a collection of data fields relevant for all forms of offers to sell. When a user enters the “sell” secure area, the system presents a particular form of offer screen to the user, with the form of the offer screen being defined by the type of transactional entity represented by the user, as defined in the users membership profile. Agricultural producers will necessarily have a different, and more commodity specific, offer screen, which contains certain data record fields that would be irrelevant to an agricultural chemical vendor, for example. Agricultural producers would need to include commodity status information, indicating the status of the crop, along with packing style information, and a grade/quality indicator along with the category, subcategory, type and variety indicia specific to the particular crop being offered.

In a manner similar to posting an offer to sell, as described above, a request for quote may also be posted by a member by that member's accessing the “buy” secured area upon which action of the system presents a request for quote screen to the user which contains similar types of data record fields as in the case of an offer to sell. A user might prepare a request for quote if the particular good or service in which they are interested does not appear in the search results, after that user has conducted either a simple or advanced search for that particular good or service. Since there are no outstanding offers to sell that pertain that particular buyer, the buyer might wish to prepare a request for quote and post it to the user community in the hopes that a producer or vendor might be able to fulfill the purchase request.

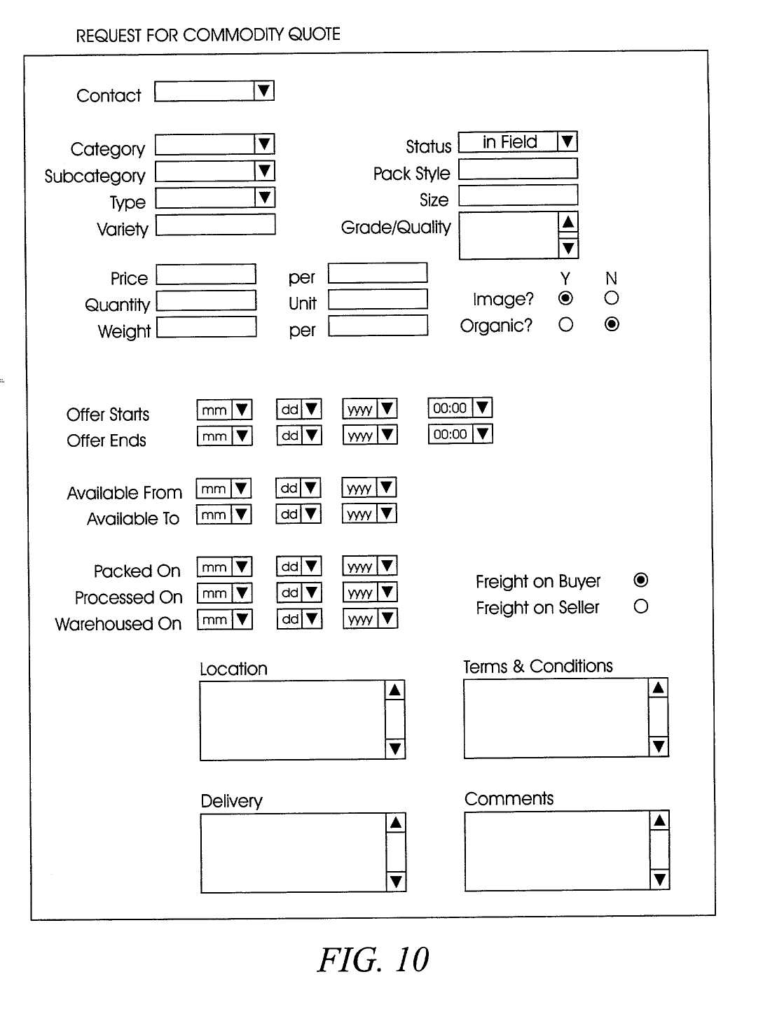

In the exemplary screen shot of FIG. 10, a request for quote is illustrated in the context of a request for agricultural commodities, products or services. A contact data record field is included which gives information as to the contact person or entity who has prepared the request. The user would indicate, through drop-down menus corresponding to the categorical, hierarchical organization of the system, what category, subcategory and/or type of commodity is being sought. The keyboard entry field allows the user to indicate a variety of the commodity if varietal information is relevant. For examine, baled alfalfa in the feeds and forages elemental category is sufficient to identify the type of commodity being sought. However, appaloosa horses in the livestock elemental category might not be a sufficient indicator if the requester is only looking for one year old colts. That type of information would necessarily be added in the variety keyboard entry field. In a manner similar to the exemplary embodiment of FIG. 9, the exemplary request screen contains fields in which a requestor might indicate a desired commodity status, packing style, size and grade/quality index. Additional data entry fields allow the requestor to input a desired price, quantity and/or weight, along with a unit or basis metric for the item's price, quantity and/or weight. Organic commodity preferences can also be indicated by the user's setting a “yes” or “no” switch.

Date and time fields allow the user to establish when the particular RFQ will begin and when it will end, along with preferred availability from dates and preferred availability to dates, if the requester wishes to put availability constraints upon the desired commodity. Further, and in accordance with the invention, the requestor is able to indicate a particular location radius in which they would prefer the commodity to be located. For example, for perishable goods, a requestor might require that the source of the commodity be located within ten miles or twenty miles of a particular city, in order to ensure that the goods will have a particular quality metric once the transaction is consummated and the goods are delivered. A textual comment field allows the requester to add further textual comments to the request if the requestor wishes to transact on the basis of terms and conditions peculiar to themselves.

Once the necessary data entry fields have been completed in either a request for quote or offer to sell, the posting is assigned an identifier by the system and the information contained within the posting is transferred to the system's data base. The data base is generally relational in form, such that a user is able to search from the basis of a number of different search metrics, with search results being returned and organized on the basis of a posting identifier. This particular functionality supports an important feature of the present invention, in that a user is able to establish a delivery radius as a search criteria, with the only pieces of data required by the system being a source city and state and a destination city and state.

It should also be understood that such delivery radius information would be of particular interest to a user who is a transportation contractor, whether a shipper or one who is seeking a shipping bid. Transportation contractors are able to source transportation offers and requests in the same manner as commodity producers and product vendors, although their data records will be structured to contain transaction parameters related to the shipping market, as opposed to a commodity or product market. Shippers would be able to indicate whether their containers (trucks for example) are refrigerated, indicate the tare weight capacity of their containers, and other similar, transport specific information. Users requesting shipping bids are able to indicate whether they will require any special environmental or handling conditions from a shipper by entering the appropriate information into the appropriate data entry field of the transportation data record. In this instance, it will be evident to one having skill in the art, that the ability to process transaction data on a geographical radius basis represents a particularly advantageous feature of the present invention. Transporters will be able to contract with only those shippers who are within a convenient and efficient transport radius.

It is well understood that cities and localities are identified by postal codes which correspond to a latitude and longitude of the identified city or locality. If a product source is located in Fresno, Calif., and a product designation located in Vidalia, Calif., it remains for the system to merely calculate a distance between those two localities on the basis of their respective assigned latitudes and longitudes. Accordingly, as a user subscribes to the system, and enters their location information, the system accesses a standardized data base (which might be a third-party data base hosted on a separate server system elsewhere on the Internet), and extracts the latitude and longitude information associated with the locality specified by the new member. That locality information is then appended to their profile and is used for that member's starting point whenever the member specifies a geographical radius indicia for either an offer, a request or a search. The system is able, accordingly, to obtain very fine-grained distance information in order to support efficient and effective transactions relating to time-sensitive or extremely perishable commodities.

At this juncture, it would be worthwhile to summarize the posting procedures supported by the trading platform in accordance with the invention. Posting an offer to sell or request for quote for commodities, products, services and transportation, is how trading platform members communicate to other members about items that are available for sale or items that are wanted for purchase. The type of offers or RFQs a member can post depends on the type of entity which has established trading platform membership. This would be the default condition. Alternatively, the “buy” and “sell” secure area access button could be replaced by a simple “post” secure area access button, with the system presenting a user with a set of post options, subdivided into offers to sell and requests for quote. Under the offer to sell selection, a user would be able to select from among offers to sell commodities, products, services or transportation, with similar options being available under the request for quote option. In addition to the selection switch, the system might give the user a further alternative of selecting, for example, an offer to sell a commodity “based on a previous offer for” and then a drop-down menu option from which previous made offers can be selected. The drop down menus would contain listings of all offers made by that user within that particular top-level category and would represent an efficient starting point for developing either a new offer or a new request posting.

In addition to preparing offers and requests, the user also has an option to modify certain information contained within certain data fields once the offer or request has been posted and while it is still active in the data base. Once an offer or request is active, the member to whom that offer or request belongs is able to modify the postings with contact information, price, quantity and offer or RFQ ending date. This particular functionality is established in the system's transaction management area and will be described in greater detail below.

Once offers and/or requests have been posted and are active on the system, buyers and sellers are able to negotiate with one another in order to establish perhaps a different or better price for an item, or a different quantity, availability date, or adjunct terms and conditions. During the negotiation process, both the potential buyer and the seller control whether the commodity, product, service or transportation will be purchased, since both parties must mutually accept the terms of the offer before a transaction is effected. Through the negotiation process, buyers and sellers respond to offers to sell and requests for quote by either accepting the original offer as is, or by submitting one or more counteroffers to the other party which modify the original posting terms. At each stage of the negotiation process, the system notifies the potential buyer and seller via e-mail, of any actions taken by the other party. In addition to the usual terms and conditions of the transaction, such as subprice, quantity and the like, the buyer and seller may also develop various payment terms and payment methodologies during the negotiation process. In this regard, special terms and conditions are captured by the negotiation process and are available for transfer to an escrow-type agency as escrow conditions, if such a payment methodology is selected by the parties. Once both parties accept an offer, the transaction is effected, and the trading platform system automatically generates a sale order of the transaction for the seller and a purchase order for the buyer.

It should be noted that in the context of the present invention, the details of an offer to sell might change during the negotiation process, but the original offer to sell is always displayed in the applicable search results regardless of whether offer details have changed during the negotiation. This particular trading platform feature allows sellers to receive multiple negotiations on an offer to sell, with each negotiation based on the original offer to sell as expressed in the search results screen. Original offers and original requests are all that are presented to a general user, with all negotiation modifications taking place in a side-channel, so to speak, where no other transactors except the two negotiators having access to the negotiation data.

The negotiation process is initiated from the offer detail screen, by a user selecting a “negotiation” function button associated with that particular offer detail. In this regard, it should be noted that in using the term “offer,” the detail could be associated with either an offer to sell or a request for quote. Once the negotiation function is selected, the negotiation process is initiated by the system's presentation layer displaying a negotiation screen to the user through which the negotiation function is performed. The negotiation screen is substantially similar to either an offer or request screen, but configured in a side-by-side, split-screen configuration, with the original offer or request information disposed on one side, and with corresponding empty modification fields disposed on the other. A user is able to view the specific terms and conditions of any given posting and is able to enter their modified term in the empty modification field. For example, in a negotiation relating to tree stock, the offer posting might have offered mission variety olive tree stock for $42.00 per tree, in 100-tree lots; with a purchaser willing to pay $41.00 per tree for the same lot size. In this particular instance, the potential purchaser need only enter the proposed $41.00 price into the price field and submit the counter to the system by accessing the appropriate “submit” button or link.

In turn, the systems populates the remaining fields with the original offer information and forwards a negotiation notice to the offeror by e-mail. At the same time, the counter is assigned a negotiation identifier number and stored in the system data base such that it is able to be accessed by either the original offeror or by the member who made the counter. As the original offeror receives e-mail, they are able to access the counter through the transaction management area and invoke the appropriate negotiation screen. Those entries in the negotiation screen which are different from the entries of an original offer are highlighted, such that an offeror is immediately able to identify those areas which a negotiator proposes to modify.

The original offeror now has the option to either accept the latest terms proposed by the buyer or may prepare a counteroffer of their own for submission to the other side in the negotiations. Additionally, either party is able to end the negotiations entirely, which action terminates the current negotiation procedure with both parties being unable to proceed any further.

In the case where an original offeror desires to make a further counter, they input their additional information into the modification fields and repeat the submission and alert process. For example, the original offeror might be willing to accept the $41.00 per tree price, but might require that the lot size be increased or that the buyer pay net ten rather than net thirty on account.

In this manner, negotiation proceeds back-and-forth, with each individual modification being captured by the system so as to maintain a step-by-step record of the transaction steps. Any of the principals in a negotiation are able to review the flow of the negotiation process by paging back through the modification side of the screen to determine a complete history of the transaction. Once the negotiation process has been completed, the seller or the buyer is able to accept the transaction as it then currently stands, by depressing an “accept” function button or link in order to inform the system that negotiations are concluded and the transaction has been made. In this regard, accepting an offer causes the system to record the transaction has having been made with regard to the information contained within the last recorded set of modification fields of the negotiation screen. This information or data set would also necessarily include all ancillary terms and conditions entered into the record's comment fields such that the entire terms and conditions of a transaction are made a matter of record for future reference.

Acceptance can be undone in certain circumstances, provided that the other party to a transaction has not yet responded to the latest counter recorded by the system. If a buyer or seller has prepared a counter and submitted it to the other party, and then decided to accept an existing offer, the party may cancel acceptance until such time as the other party responds to the outstanding counter recorded within the system. However, once a party receives a counter and accepts the terms and conditions contained within, the transaction is deemed made and the system automatically closes out the transaction; generating a sale order for the seller and a purchase order for the buyer. The generation of a sale order and purchase order finalizes the deal and the negotiation process.

At this juncture, it should be worth noting that the specific form of the negotiation screen, and the organization and content of the original offer or request and modification fields will necessarily depend upon whether the particular item being offered or desired is an agricultural commodity, product, service or transportation item. In each case, there will be slightly different fields displayed on the negotiation screen, with those fields being particular and specific to the item being transacted. For example, a product negotiation might be performed with respect to an item having a manufacturer designation, model number or SKU number, while an agricultural commodity negotiation might be made with regard to an item having variety, status, packing style, size and grade/quality metrics. It will be understood by those having skill in the art, that different marketplace items will have naturally different characteristics, with those different characteristics being transported along with the items across the various functional aspects of the trading platform.

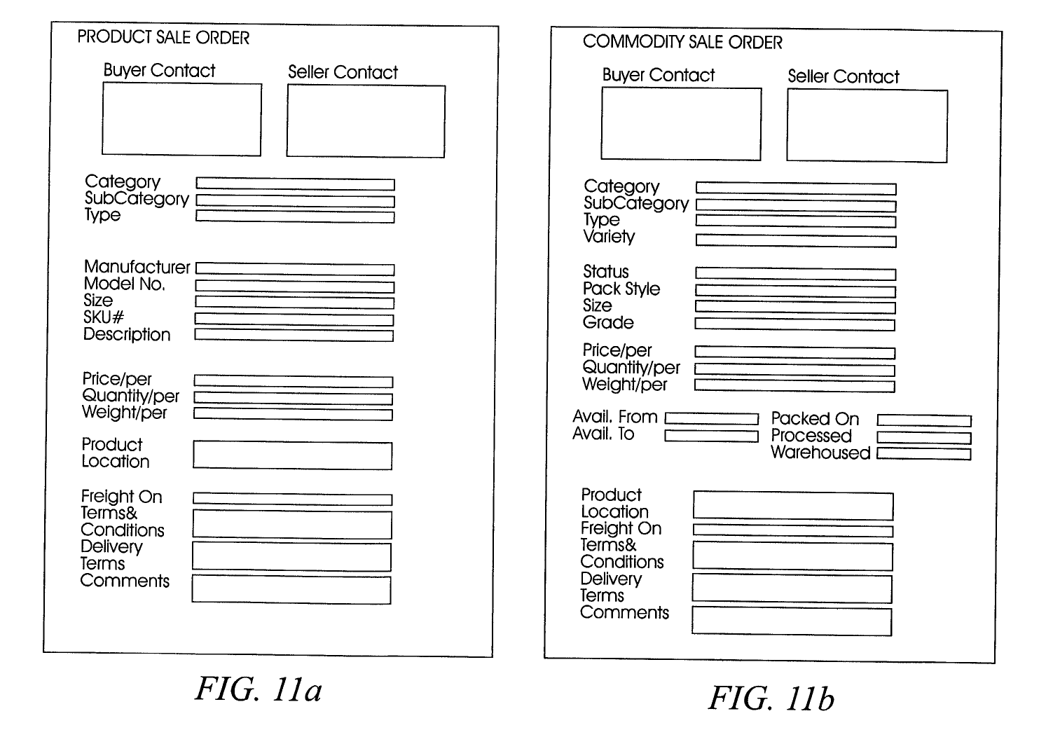

FIGS. 11a and 11b are exemplary screen shots of product and commodity sales orders, respectively, which are automatically generated by the trading platform system, once both the buyer and seller have accepted the latest negotiation on the offer. Although FIGS. 11a and 11b represent sales orders, a corresponding purchase order, substantially similar in form and content, is automatically generated by the trading platform system for the other party. The sale order record is an important feature to practice of principles of the invention, since the trading platform is enabled to automatically transfer a record copy of the transaction summation not only to the parties concerned, but also to a financial institution, such as an escrow agency, so that mutually agreed terms and conditions can be established as escrow criteria, for example, before funds are transferred. The sales orders, as illustrated in the exemplary embodiments of FIGS. 11a and 11b are again differentiated by the type of item having been transacted with respect to. In FIG. 11a, the product sale order identifies the item in terms of a manufacturer, model number, a size, SKU number or description, while the commodity sale order depicted in FIG. 11b identifies the item with respect to status, packing style, size, grade/quality, and the like. Again, the particular characteristics of items are transported across the various functional blocks of the platform.

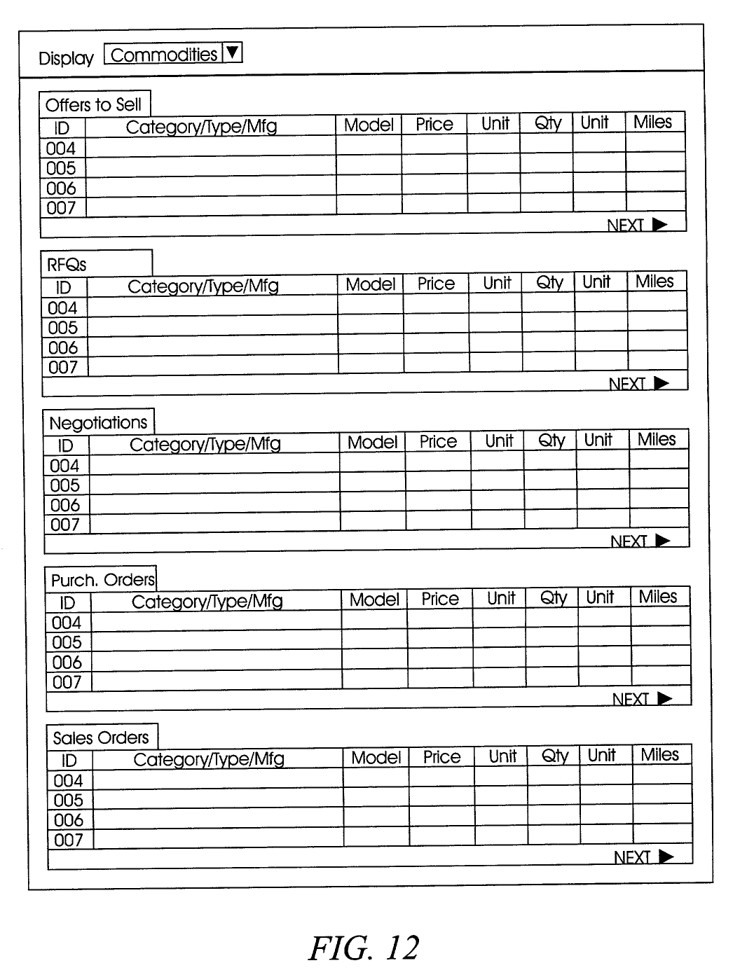

A further aspect of the system according to the invention is found in a transaction management secured area in which a transaction management engine allows members to manage their transaction platform transactions and membership information. The transaction management area is a secure area, such that only members or users assigned to a company membership, have access to information contained within the section. Once the transaction management area is traversed, users/members area able to access system information in the following two areas: transaction data, illustrated in the exemplary screen shot of FIG. 12, which contains information on all transactions conducted for the account, including offers to sell, requests for quote, negotiations, sales orders, purchase orders and active offers outstanding, and membership data, illustrated in FIG. 13, which contains information regarding the member company and users associated with the company account. The membership data area is where the designated company account administrators are able to manage a company's account information by editing, adding or deleting company users, company locations and/or company contacts, mailing and billing information.

As depicted in the exemplary embodiment of FIG. 12, the transaction data section presents information in substantially the same form as the system's search result screen, but organized in a form that is pertinent to a particular member or membership entity. The transaction data section presents offers, requests, negotiations, purchase and sales orders in a series of data fields, with the data field types, i.e., commodities, products, services and/or transportation, being identified by a “display” parameter at the top of the transaction data section. Through the transaction management engine, a member is able to obtain immediate and real time information on both outstanding transactions that are currently pending with the system, as well as information on the historical record of all transactions made by that membership entity through the system. It should further be noted that historical records of offers and/or requests are able to form the basis of subsequent offers and/or requests when the membership entity desires to initiate a new transaction. Data from historical records can be immediately used to populate the data fields of a new offer or request form with the user only needing to modify certain of those fields as necessary.

A further feature of the invention is represented by an analysis area in which an analysis engine is able to display a large number of reports generated from information contained within the data base and configured to meet the needs of the various types of transactors accessing the system. Reports generated by the analysis engine might include a real-time aggregation of price and supply data, for example, which would be extremely useful to both buyers and sellers of agricultural commodities.

In one particular aspect of the invention, price and quantity information can be overlaid onto an agricultural region graphical map, such as a county map, as either a bar chart or a color chart. For example, since the system is able to access the data base and determine from the various offers contained within the quantities being offered for sale on a geographic location basis, the system can plot offered quantities locale-by-locale. An agricultural producer is able to access this graphical analysis and view a commodity supply condition over an agricultural region as a whole. Depending on the state of commodity supply, a grower would be able to decide when or even whether to harvest the crop, particularly if the analysis results indicate a huge supply condition obtaining in their local agricultural region. This condition would likely depress prices for that commodity to such an extent that it would be uneconomic to even enter the marketplace. Similarly, giving an agricultural producer the ability to view a graphical representation of supply/demand allows the producer to identify “hot spots” of supply/demand, with the producer likely to post offers for sale into a “demand” hot spot, while a purchaser would be likely to post requests into a “supply” hot spot.

The system is able to develop these analysis tools by making use of the postal code/latitude/longitude artifact relating to particular localities and by allocating price/quantity data captured in the system data base into county or region locations which bound a particular collection of localities. Thus, all of the price/quantity information relating to commodities within the vicinity of Vidalia, Calif., will appear, either as a bar or a color code, on a map of California in the region of Vidalia.

In addition to providing prompt, real-time aggregate trend data, the analysis engine can extract and process data from the data base in order to assist an agricultural producer or product vendor in establishing just-in-time production planning modalities or crop rotation and definition schemes. System data base resources can be accessed in order to establish long-term trend data for product demand, commodity pricing, and the like. Manufacturers of agricultural products are able to establish manufacturing time tables to meet peak demands, without requiring them to maintain large inventories, or a large workforce during times of moderate-to-low demand. Similarly, long-term trend data might establish that there will be an increasing supply of a particular agricultural commodity within the next two to three growing seasons, allowing an agricultural producer to switch to a low-supply, high-demand crop at just the right point in time.

Those having skill in the art will, of course, be able to develop additional reports and presentations that might be of interest to buyers, sellers and/or shippers of the various items being transacted through the trading platform, given the scope and extent of the information contained within the platform's data base. The particular utility of the present invention is that this information can be processed and presented to a user in a graphical form, where the graphics can be bounded by and correspond to particular agricultural regions, counties, localities, appellations, within a given state or national region. The ability to view analysis results and trend data on a graphical basis, allows information to be presented to a user in a form that is readily identifiable and susceptible of easy understanding.

It is important to note that while the present invention has been described in the context of a fully functional set of data processing systems, presentation screens, activity windows and the like, those skilled in the art will appreciate that the systems and mechanisms in the present invention are capable of being implemented in a variety of forms and formats, and that the present invention applies equally regardless of the particular type of network being used to distribute the information, and indeed the specific form and format of the information being distributed over the network. Transaction items supported by the trading platform are certainly not limited to those items shown in the exemplary or illustrative embodiments described above, but rather include all manner of marketplace items, susceptible of two-way transactional negotiation. The clear superiority of this form of trading platform over conventional electronic “B-to-B exchanges” or options, suggest that various other commodity markets not specifically discussed above, might also be implemented in accordance with the systems and methods of the present invention.

While the invention has been particularly shown and described with reference to the above-discussed exemplary embodiments, it will be understood by those skilled in the art that various changes and modifications in form and detail may be made to those exemplary embodiments without departing from the scope and spirit of the present invention which is defined only with regard to the following claims.

1. A method for effecting transactions in an agriculture related marketplace, the method comprising:
establishing a communication network, the network defining a community of buyers and sellers of agriculture related items;
subdividing the agriculture related market place into a plurality of top-level markets, each top-level market defining a particular categorical hierarchy of items comprising the totality of the agriculture related market place;
receiving a first multiplicity of offers to sell, over the communication network, from a plurality of selling entities, each offer to sell including item transaction data organized in accordance with a corresponding one of the plurality of top-level markets;
receiving a second multiplicity of offers to buy, over the communication network, from a plurality of buying entities, each offer to buy including item transaction data organized in accordance with a corresponding one of the plurality of top-level markets;
displaying said first multiplicity of offers to sell and second multiplicity of offers to buy to the community of buyers and sellers over the communication network; and
executing at least one transaction between a buyer and a seller with respect to a particular item, by a buyer's making an electronic indication on a respective posted offer to sell for that particular item.

2. The method according to claim 1, further comprising the step of executing at least one transaction between a buyer and a seller with respect to a particular item by a seller's making an electronic indication on a respective posted offer to buy for that particular item.

3. The method according to claim 1, further comprising:
establishing a database, the database structured in accordance with a categorical hierarchical structure, the top-level categories of the database corresponding to the top-level market subdivisions comprising the agriculture related marketplace; and
searching the database for offers to sell or offers to buy within a particular top-level market subdivision.

4. The method according to claim 3, further comprising:
organizing each of the top-level market subdivisions into corresponding multiplicities of item categories; and
searching the database for offers to sell or offers to buy within particular ones of the item categories.

5. The method according to claim 4, wherein the top-level subdivisions are ones selected from the group consisting of commodities, products, services and transportation, and wherein the item categories correspond to rational groupings of items within each such top-level subdivision.

6. The method according to claim 5, further comprising:
associating a participating entity with a corresponding one of a plurality of entity types, wherein each entity type is associated with a corresponding top-level market subdivision; and
presenting item transaction data to a participating entity in the form of a data record, the data record containing item transaction indicia specific to the participating entity's type.

7. The method according to claim 6, wherein the entity types are ones selected from the group consisting of commodity producers/brokers, product vendors, service providers and transportation contractors.

8. A method for effecting efficient electronic transactions in an agricultural marketplace, comprising:
establishing an agricultural trading platform, including a communication network linking a community of buyers and sellers of agricultural items;
establishing a database, the database structured in accordance with a categorical hierarchical structure, the top-level categories of the database corresponding to top-level market subdivisions comprising the agriculture related marketplace;
receiving a multiplicity of transaction notices from a corresponding multiplicity of participating entities over the communication network, each transaction notice including item transaction indices data organized in accordance with a corresponding one of the plurality of top-level markets;
searching the database for transaction notices in accordance with a selected category of the categorical hierarchical structure;
displaying transaction notices that satisfy the selected search category;
accessing selected ones of the displayed transaction notices, so as to display a detail of the corresponding item transaction indices data; and
responding to an accessed transaction notice so as to complete a transaction.

9. The method according to claim 8, the responding step further comprising:
electronically modifying at least one item transaction index by a negotiating entity; and
submitting the modified transaction notice to a participating entity that originated the transaction notice.

10. The method according to claim 9, wherein the transaction notice is an item sale offer or an item buy offer.

11. The method according to claim 10, the responding step further comprising:
repeating the electronically modifying and submitting steps between an originating entity and the negotiating entity, in alternating fashion until the item transaction indices of the transaction notice are acceptable to both parties;
maintaining a historical record of each modification, by either party, in the database; and
generating an electronic transaction consummation record containing final item transaction indices agreed upon by both parties.

12. The method according to claim 11, further comprising the step of forwarding the transaction consummation record to a third-party financial institution, wherein the agreed item transaction indices define the transaction conditions, the satisfaction of which triggers a transfer of funds.

13. The method according to claim 11, further comprising:
organizing each of the top-level market subdivisions into corresponding multiplicities of item categories; and
searching the database for transaction notices within particular ones of the item categories.

14. The method according to claim 13, wherein the top-level subdivisions are ones selected from the group consisting of commodities, products, services and transportation, and wherein the item categories correspond to rational groupings of items within each such top-level subdivision.

15. The method according to claim 14, further comprising:
associating a participating entity with a corresponding one of a plurality of entity types, wherein each entity type is associated with a corresponding top-level market subdivision; and
wherein each participating entity generates transaction notices in the form of a data record, the data record containing item transaction indicia specific to the participating entity's type.

16. A method for effecting efficient electronic transactions in an agricultural marketplace, comprising:
establishing an agricultural trading platform, including a communication network linking a community of participating buyers and sellers of agricultural items;
establishing a database, the database structured in accordance with a categorical hierarchical structure, the top-level categories of the database corresponding to top-level market subdivisions comprising the agriculture related marketplace, the database containing a plurality of transaction offer notices for agricultural items organized in accordance with a corresponding one of the plurality of top-level markets;
establishing a set of blank transaction offer notices in the form of a data record defining a transaction's parameters, each participating entity providing appropriate transaction parameters in the data record;
receiving completed transaction offer notices and storing said notices in the database;
searching the database for transaction notices in accordance with a query corresponding to at least one transaction parameter;
displaying transaction notices that satisfy the selected search query;
accessing selected ones of the displayed transaction notices, so as to display a detail of the corresponding item transaction indices data; and
responding to an accessed transaction notice so as to complete a transaction.

17. The method according to claim 16, wherein the data record of the transaction offer notices is structured to contain transaction parameters specific to each separate one of the top-level market subdivisions.

18. The method according to claim 17, further comprising:
associating a participating entity with a corresponding one of a plurality of entity types, wherein each entity type is associated with a corresponding top-level market subdivision; and
presenting a participating entity with blank transaction notices containing transaction parameters corresponding to their entity type.

19. The method according to claim 18, wherein the top-level subdivisions are ones selected from the group consisting of commodities, products, services and transportation, and wherein the item categories correspond to rational groupings of items within each such top-level subdivision.

20. The method according to claim 19, wherein the entity types are ones selected from the group consisting of commodity producers/brokers, product vendors, service providers and transportation contractors.

21. The method according to claim 20, wherein the transaction parameters include an item location indication and the searching step comprises searching for transactions for particular items within a specified geographical radius of a search entity.

22. The method according to claim 21, wherein the transaction parameters include a top-level market indication and the searching step comprises searching for transactions for particular items within a specified top level market.

23. The method according to claim 22, wherein the transaction parameters include a top-level market indication, an item category indication and an item location indication and wherein the searching step comprises searching for transactions for particular items within a specified top level market, an item category and within a specified geographical radius of a search entity.

24. A system for effecting efficient electronic transactions in an agricultural marketplace, comprising:
an agricultural trading platform, including a communication network linking a community of participating buyers and sellers of agricultural items, the trading platform including a server system coupled to user access devices over the communication network;
a database, the database structured in accordance with a categorical hierarchical structure, the top-level categories of the database corresponding to top-level market subdivisions comprising the agriculture related marketplace, the database containing a plurality of transaction offer notices for agricultural items organized in accordance with a corresponding one of the plurality of top-level markets;
a set of blank transaction offer notices in the form of a data record defining a transaction's parameters, each participating entity providing appropriate transaction parameters in the data record;
a plurality of completed transaction offer notices stored in the database;
a search engine, hosted by the server system, the search engine searching the database for transaction notices in accordance with a query corresponding to at least one transaction parameter; and
a negotiation engine, hosted by the server system, the negotiation engine facilitating an electronic transfer of a modified transaction offer notice between an originating party and a negotiating party.

25. The system according to claim 24, further comprising:
a posting engine, the posting engine presenting blank transaction offer notices to a participating entity, the posting engine storing completed transaction offer notices in the database for access by the search engine; and
a management engine, coupled to the database, the management engine organizing and displaying a history of transaction notices originated by and transactions completed by a corresponding participating entity.

26. The system according to claim 25, wherein the search, negotiation, and posting engines interact with a participating entity over a set of user specific presentation screens, the presentation screens accessible by a user through a browser application.
